(19) United States
(12) Patent Application Publication
(10) Pub. No.: US 2015/0037689 A1
(43) Pub. Date: Feb. 5, 2015

(54) LITHIUM SECONDARY BATTERY

(71) Applicant: SUMITOMO ELECTRIC INDUSTRIES, LTD., Osaka-shi, Osaka (JP)

(72) Inventors: Junichi Nishimura, Osaka-shi (JP); Kazuhiro Gotou, Itami-shi (JP); Akihisa Hosoe, Osaka-shi (JP); Kentarou Yoshida, Itami-shi (JP)

(21) Appl. No.: 14/382,787

(22) PCT Filed: Feb. 22, 2013
(86) PCT No.: PCT/JP2013/054531

§ 371 Date: Sep. 4, 2014

(30) Foreign Application Priority Data
Mar. 22, 2012 (JP) 2012-064980

(51) Int. Cl. H01M 4/80; H01M 4/52; H01M 10/052; H01M 4/583; H01M 4/485; H01M 4/38; H01M 4/66; H01M 4/50

(52) U.S. Cl. CPC H01M 4/80; H01M 4/661; H01M 4/523; H01M 4/502; H01M 4/583; H01M 4/485; H01M 4/382; H01M 4/38; H01M 10/052; H01M 2300/0068; H01M 2220/20; H01M 2220/30
USPC 429/322; 429/233; 429/245; 429/231.3; 429/223; 429/224; 429/231.8; 429/231.1; 429/231.95; 429/231.6; 429/218.1

(57) ABSTRACT

Provided is a lithium secondary battery with three-dimensional network porous bodies as current collectors in which the internal resistance does not increase even after repeated charging and discharging. A lithium secondary battery including a positive electrode and a negative electrode each having as a current collector a three-dimensional network porous body, the positive electrode and the negative electrode being formed by filling at least an active material into pores of the three-dimensional network porous bodies, wherein the three-dimensional network porous body for the positive electrode is a three-dimensional network aluminum porous body having a hardness of 1.2 GPa or less, and the three-dimensional network porous body for the negative electrode is a three-dimensional network copper porous body having a hardness of 2.6 GPa or less.

### TECHNICAL FIELD

The present invention relates to a lithium secondary battery with a lithium ion conductive solid electrolyte membrane.

### BACKGROUND ART

In recent years, an increase in energy density is expected for batteries which are used as electric power supplies of portable electronic devices such as mobile telephones and smartphones, and electric vehicles and hybrid electric vehicles respectively using a motor as a power source. Particularly, a lithium-ion secondary battery is actively researched in various fields as a battery which enables to achieve high energy density, since lithium has a small atomic weight and is a substance with large ionization energy.

An organic electrolytic solution is used as an electrolytic solution for current lithium-ion secondary batteries. However, although the organic electrolytic solution exhibits high ionic conductivity, the organic electrolytic solution is a flammable liquid. Therefore, installation of a protection circuit for the lithium-ion secondary battery can become necessary when the organic electrolytic solution is used as an electrolytic solution of a battery. In addition, when the organic electrolytic solution is used as an electrolytic solution, a metal negative electrode can be passivated due to the reaction of the negative electrode with the organic electrolytic solution, resulting in an increase in impedance. As a result, current becomes concentrated at a portion with low impedance to generate a dendrite. In addition, the dendrites penetrate a separator present between the positive electrode and the negative electrode. Therefore, a case of internal short-circuit of a battery occur easily.

Therefore, there is a technical object of further improving safety of the lithium-ion secondary battery and of further enhancing the performance of the lithium-ion secondary battery.

Thus, in order to achieve the above-mentioned object, a lithium-ion secondary battery in which a safer inorganic solid electrolyte is used in place of the organic electrolytic solution is studied. Since the inorganic solid electrolyte is generally nonflammable and has high heat resistance, development of an all-solid lithium secondary battery in which the inorganic solid electrolyte is used is desired.

For example, Patent Literature 1 discloses that lithium ion conductive sulfide ceramic is used as an electrolyte of an all-solid battery wherein lithium ion conductive sulfide ceramic includes Li₂S and P₂S₅ and has the composition of 82.5 to 92.5 of Li₂S and 7.5 to 17.5 of P₂S₅ in terms of % by mole.

Patent Literature 2 discloses that highly ion conductive ionic glass, in which an ionic liquid is introduced into ionic glass represented by the formula MₐX-M_{b}Y (wherein M is an alkali metal atom, X and Y are respectively selected from among SO₄, BO₃, PO₄, GeO₄, WO₄, MoO₄, SiO₄, NO₃, BS₃, PS₄, SiS₄ and GeS₄, “a” is a valence of X anion and “b” is a valence of Y anion), is used as a solid electrolyte.

Patent Literature 3 discloses an all-solid lithium-ion secondary battery including a positive electrode containing as a positive electrode active material, a compound selected from the group consisting of transition metal oxides and transition metal sulfides; a lithium ion conductive glass solid electrolyte containing Li₂S; and a negative electrode containing a metal that forms an alloy with lithium as an active material, wherein at least one of the positive electrode active material and the negative electrode active material contains lithium.

Moreover, Patent Literature 4 discloses that an electrode material sheet is used as a current collector of an electrode of an all-solid lithium-ion secondary battery, wherein the electrode material sheet is formed by inserting an inorganic solid electrolyte into pores of a porous metal sheet having a three-dimensional network structure in order to improve the flexibility and mechanical strength of an electrode material layer in an all-solid battery to suppress lack and cracks of the electrode material and peeling of the electrode material from the current collector, and in order to improve the contact property between the current collector and the electrode material as well as the contact property between electrode materials.

When the current collector has a three-dimensional network structure, the contact area between the current collector and the active material increases. Therefore, use of such a current collector can reduce the internal resistance of the battery and improve the battery efficiency. Further, since use of the current collector can improve circulation of an electrolytic solution and prevent current crowding and formation of Li dendrites which is a conventional problem, improvement of battery reliability, inhibition of heat generation and an increase in battery power can be achieved. Moreover, since the current collector has concave-convex on the skeleton surface, the current collector enables improvement of active material retention, inhibition of exfoliation of an active material, securement of a large specific surface area, improvement of active material use efficiency and a further increase in battery capacity.

Patent Literature 5 discloses that a metal porous body is used as a current collector, wherein the metal porous body is obtained by subjecting a skeleton surface of a synthetic resin having a three-dimensional network structure to a primary conductive treatment by non-electrolytic plating, chemical vapor deposition (CVD), physical vapor deposition (PVD), metal coating or graphite coating, and further subjecting the skeleton surface to a metallization treatment by electroplating.

It is said that a material of a current collector of a positive electrode for a general-purpose lithium-based secondary battery is preferably aluminum. However, since aluminum has a lower standard electrode potential than hydrogen, water is electrolyzed prior to plating of aluminum in an aqueous solution. Therefore, it is difficult to plate aluminum in an aqueous solution.

On the other hand, Patent Literature 6 discloses an aluminum porous body is used as a current collector for a battery, wherein the aluminum porous body is obtained by forming an aluminum coating on the surface of a polyurethane foam with molten salt plating, and then removing the polyurethane foam.

On the other hand, in an all-solid battery, there is a problem that unless the state of joining at the interface between the electrode and the solid electrolyte membrane is good, battery characteristics, particularly, charge-discharge cycle characteristics are remarkably deteriorated due to defective contact. As a result, it is proposed that a pressure is applied to the all-solid battery to make good contact between the electrode and the solid electrolyte membrane (refer to Patent Literatures 7 and 8).

Now then, in the all-solid battery, a thin solid electrolyte membrane is preferred since the resistance is reduced. However, when a pressure was applied to an all-solid lithium ion battery which was prepared by using a three-dimensional network aluminum porous body as a current collector for a positive electrode, a three-dimensional network copper porous body as a current collector for a negative electrode, and a solid electrolyte membrane as an electrolyte, it was found that in the all-solid lithium ion battery, there was a case where that the solid electrolyte membrane is broken and the battery is short-circuited.

### CITATION LIST

### Patent Literatures

Patent Literature 1: Japanese Unexamined Patent Publication No. 2001-250580
Patent Literature 2: Japanese Unexamined Patent Publication No. 2006-156083
Patent Literature 3: Japanese Unexamined Patent Publication No. 1996-148180
Patent Literature 4: Japanese Unexamined Patent Publication No. 2010-40218
Patent Literature 5: Japanese Unexamined Patent Publication No. 1995-22021
Patent Literature 6: WO 2011/118460 A
Patent Literature 7: Japanese Unexamined Patent Publication No. 2000-106154
Patent Literature 8: Japanese Unexamined Patent Publication No. 2008-103284

### DISCLOSURE OF INVENTION

### Technical Problem

It is an object of the present invention to provide a lithium secondary battery having a three-dimensional network porous body as a current collector, in which short circuit of a battery due to breakage of a solid electrolyte membrane does not occur.

### Solution to Problem

As a result of intensive study by the present inventors in order to solve the above-mentioned problems, the present inventors found that the problems can be solved by using a three-dimensional network aluminum porous body, hardness of which is controlled so as to be a specific value or less by an annealing treatment, as a current collector for a positive electrode, and using a three-dimensional network copper porous body, hardness of which is controlled so as to be a specific value or less by an annealing treatment, as a current collector for a negative electrode, in a lithium secondary battery in which a three-dimensional network metal porous body is used as a current collector. Then, these findings have now led to completion of the present invention.

That is, the present invention pertains to a lithium secondary battery as described below.

(1) A lithium secondary battery including a positive electrode and a negative electrode each having as a current collector a three-dimensional network porous body, the positive electrode and the negative electrode being formed by filling at least an active material into pores of the three-dimensional network porous bodies, wherein the three-dimensional network porous body for the positive electrode is a three-dimensional network aluminum porous body having a hardness of 1.2 GPa or less, and the three-dimensional network porous body for the negative electrode is a three-dimensional network copper porous body having a hardness of 2.6 GPa or less.

(2) The lithium secondary battery according to the above item (1), wherein the three-dimensional network aluminum porous body is obtained by heat-treating an aluminum porous body in a reducing atmosphere or an inert atmosphere at a temperature of 250 to 400° C. for 1 hour or more, and then cooling the aluminum porous body by air cooling or cooling in a furnace.

(3) The lithium secondary battery according to the above item (1) or (2), wherein the three-dimensional network copper porous body is obtained by heat-treating a copper porous body in a reducing atmosphere or an inert atmosphere at a temperature of 400 to 650° C. for 1 hour or more, and then cooling the copper porous body by air cooling or cooling in a furnace.

(4) The lithium secondary battery according to any one of the above items (1) to (3), wherein the active material for the positive electrode is at least one selected from the group consisting of lithium cobalt oxide (LiCoO₂), lithium nickel oxide (LiNiO₂), lithium cobalt nickel oxide (LiCoₓNi₁₋ₓO₂; 0<x<1), lithium manganese oxide (LiMn₂O₄) and a lithium manganese oxide compound (LiM_{y}Mn_{2-y}O₄); M=Cr, Co or Ni, 0<y<1), and the active material for the negative electrode is graphite, lithium titanium oxide (Li₄Ti₅O₁₂), a metal selected from the group consisting of Li, In, Al, Si, Sn, Mg and Ca or an alloy including at least one of the above metals.

(5) The lithium secondary battery according to the above item (4), wherein a solid electrolyte is contained in the pores of the three-dimensional network porous body, and the solid electrolyte is a sulfide solid electrolyte containing lithium, phosphorus and sulfur as constituent elements.

### Advantageous Effects of Invention

The lithium secondary battery of the present invention exhibits the effect of improving cycle characteristics since it has a high power, has no risk of short circuit and does not undergo an increase in internal resistance even after repeated charging and discharging.

### BRIEF DESCRIPTION OF DRAWING

FIG. 1 is a longitudinal sectional view showing a basic constitution of a lithium secondary battery.

### DESCRIPTION OF EMBODIMENTS

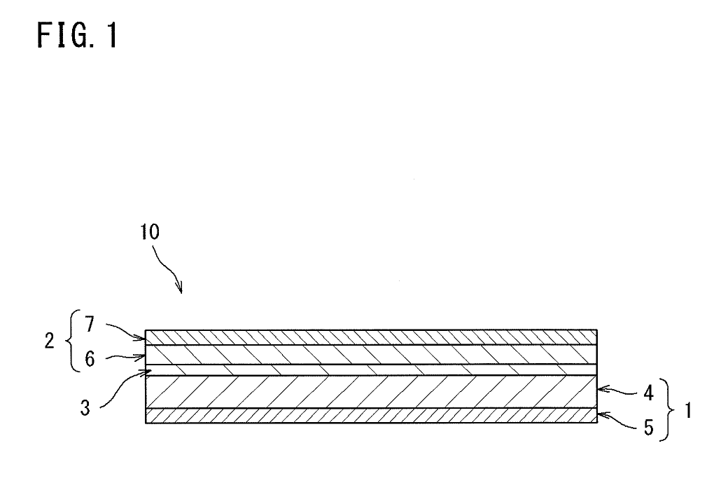

FIG. 1 is a longitudinal sectional view showing a basic constitution of a lithium secondary battery 10. Hereinafter, an all-solid lithium secondary battery will be described as an example of the lithium secondary battery 10.

The secondary battery 10 includes a positive electrode 1, a negative electrode 2, and a solid electrolyte layer (SE layer) 3 disposed between both the electrodes 1 and 2. The positive electrode 1 including a positive electrode layer (positive electrode body) 4 and a current collector 5 of positive electrode. Further, the negative electrode 2 including a negative electrode layer 6 and a current collector 7 of negative electrode.

In the present invention, the positive electrode 1 including a three-dimensional network aluminum porous body that is a current collector of positive electrode, and a positive electrode active material powder and a lithium ion conductive solid electrolyte which are respectively filled into pores of the three-dimensional network aluminum porous body. The negative electrode 2 including a three-dimensional network copper porous body that is a current collector of negative electrode, and a negative electrode active material powder which is filled into pores of the three-dimensional network copper porous body.

In some cases, a conduction aid can be further filled into pores of the three-dimensional network aluminum porous body or the three-dimensional network copper porous body.

In addition, in the present specification, the three-dimensional network aluminum porous body and the three-dimensional network copper porous body can be collectively called a “three-dimensional network metal porous body.”

(Three-Dimensional Network Metal Porous Body)

An all-solid secondary battery, which includes a three-dimensional network aluminum porous body as a current collector for a positive electrode and a three-dimensional network copper porous body as a current collector for a negative electrode, has a risk of short circuit, as described above. The short circuit of the battery is thought to occur in the case where a metal skeleton of the three-dimensional network metal porous body breaks through the solid electrolyte membrane in applying a pressure to the all-solid secondary battery when the mechanical strength of the three-dimensional network metal porous body is high. Thus, in the present invention, the battery is adapted to prevent the short circuit by subjecting the three-dimensional network metal porous body to an annealing treatment to soften the metal skeleton.

Further in the lithium secondary battery of the present invention, since the three-dimensional network metal porous body is used as a current collector, the contact area between the current collector and the active material is large. Therefore, the lithium secondary battery of the present invention exhibits low internal resistance and develops high battery efficiency. Moreover, in the lithium secondary battery of the present invention, circulation of the electrolytic solution in the current collector is enhanced, and current crowding is prevented. Accordingly, the lithium secondary battery of the present invention has high reliability, and can suppress heat generation and increase the battery power. Since the three-dimensional network metal porous body has concave-convex on the skeleton surface, improvement of active material retention, inhibition of exfoliation of an active material, an increase in specific surface area, improvement of active material use efficiency and a further increase in battery capacity can be achieved by using the three-dimensional network metal porous body as the current collector.

The three-dimensional network metal porous body can be obtained by forming a metal film having a desired thickness on the surface of a resin base material, such as a nonwoven fabric or a porous resin molded body having continuous pores such as a urethane foam, with a use of a method such as a plating method, a vapor deposition method, a sputtering method, or a thermal spraying method, and then removing the resin base material from the resulting metal-resin composite porous body. Hereinafter, the nonwoven fabric and the porous resin molded body are occasionally referred to as a “resin base material.”

—Resin Base Material (Nonwoven Fabric)—

In the present invention, a nonwoven fabric of a fiber made of a synthetic resin (hereinafter, referred to as a “synthetic fiber”) is used as a nonwoven fabric. The synthetic resin used for the synthetic fiber is not particularly limited. As the synthetic resin, publicly known or commercially available synthetic resins can be used. Among the synthetic resins, thermoplastic resins are preferred. Examples of the synthetic fiber include fibers made of olefin homopolymers such as polyethylene, polypropylene, and polybutene; fibers made of olefin copolymers such as an ethylene-propylene copolymer, an ethylene-butene copolymer, and a propylene-butene copolymer; and mixtures thereof. In addition, hereinafter, the fibers made of olefin homopolymers and the fibers made of olefin copolymers are collectively called “polyolefin resin fibers.” Further, the olefin homopolymers and the olefin copolymers are collectively called “polyolefin resins.” The molecular weight and the density of the polyolefin resin composing the polyolefin resin fiber are not particularly limited, and can be appropriately determined according to the kind of the polyolefin resin, and the like. Further, a core-sheath type composite fiber composed of two components having different melting points can be used as the synthetic fiber.

—Resin Base Material (Porous Resin Molded Body)—

As the material of the porous resin molded body, a porous body made of any synthetic resin can be selected. Examples of the porous resin molded body include foams of synthetic resins such as polyurethane, a melamine resin, polypropylene, and polyethylene. In addition, the porous resin molded body is not limited to the foam of a synthetic resin and can also be a resin molded body having continuous pores (interconnected pores). A resin molded body having any shape can be used as the porous resin molded body. For example, a resin molded body having a shape like a nonwoven fabric formed by tangling a fibrous synthetic resin can be used in place of a foam of a synthetic resin. The porous resin molded body preferably has a porosity of 80% to 98%. Further, the porous resin molded body preferably has a pore diameter of 50 to 500 μm. Among the porous resin molded bodies, a foam of polyurethane (polyurethane foam) and a melamine resin foam can be preferably used as the porous resin molded body, since the foam of polyurethane and the melamine resin foam have a high porosity, interconnection of pores and excellent thermal decomposability.

Of the porous resin molded bodies, since the foam of a synthetic resin often contains residual materials such as a foaming agent used in the manufacturing process of the foam and an unreacted monomer, it is preferred from the viewpoint of smoothly performing the subsequent steps in the production of the three-dimensional network metal porous body to previously subject the foam of a synthetic resin to be used to a washing treatment. In the porous resin molded body, a three-dimensional network is configured as a skeleton, and therefore continuous pores are configured as a whole. The skeleton of the polyurethane foam has a substantially triangular shape in a cross-section perpendicular to its extending direction. The porosity is defined by the following equation:

Porosity=(1−(mass of porous resin molded body (g)/(volume of porous resin molded body (cm³)×material density)))×100(%)

Further, the pore diameter is determined by magnifying the surface of the porous resin molded body in a photomicrograph or the like, counting the number of pores per inch (25.4 mm), and calculating an average pore diameter by the following equation: average pore diameter=25.4 mm/number of pores.

Among the resin base materials, particularly, the polyurethane foam is preferred for the purpose of securing uniformity of pores, ease of availability and the like. A nonwoven fabric is preferred for the purpose of obtaining a three-dimensional network metal porous body having a small pore diameter.

—Conductive Treatment and Formation of Metal Coating—

Examples of a method of forming a metal coating on the surface of the resin base material include a plating method, a vapor deposition method, a sputtering method, and a thermal spraying method. Among these methods, the plating method is preferred.

When a metal coating is formed by the plating method, first, a conductive layer is formed on the surface of the resin base material to allow the base material to have electrical conductivity. Since the conductive layer serves to enable formation of the metal coating on the surface of the resin base material by the plating method or the like, the material and the thickness of the conductive layer are not limited as long as it has the electrical conductivity. The conductive layer is formed on the surface of the resin base material by various methods by which the electrical conductivity can be imparted to the resin base material. As the method of imparting the electrical conductivity to the resin base material, any method of, for example, a non-electrolytic plating method, a vapor deposition method, a sputtering method, and a method of applying a conductive coating material containing conductive particles such as carbon particles can be employed.

The material of the conductive layer is preferably the same material as that of the metal coating.

Examples of the non-electrolytic plating method include publicly known methods, for example, a method including the steps of washing, activation and plating.

As the sputtering method, various publicly known sputtering methods, for example, a magnetron sputtering method can be employed. In the sputtering method, materials such as aluminum, nickel, chromium, copper, molybdenum, tantalum, gold, an aluminum-titanium alloy, and a nickel-iron alloy can be used as the material for formation of the conductive layer. Among these metals, aluminum, nickel, chromium and copper, and alloys mainly made of these metals are suitable in view of cost.

In the present invention, it is also possible to use, as the conductive layer, a layer including a powder of at least one material selected from the group consisting of graphite, titanium and stainless steel. Such a conductive layer can be formed by applying a slurry onto the surface of the resin base material, the slurry being formed by mixing a powder of, for example, graphite, titanium or stainless steel with a binder. In this case, the powder is hardly oxidized in an organic electrolytic solution, since the powder has oxidation resistance and corrosion resistance. The powders can be used alone or in admixture of not less than two kinds. Among these powders, the powder of graphite is preferred. As the binder, for example, polyvinylidene fluoride (PVDF) and polytetrafluoroethylene (PTFE), which are fluorine resin-based binders having excellent resistance to electrolytic solution and oxidation resistance, are suitable. In the current collector of the three-dimensional network metal porous body like that in the present invention, since the skeleton exists so as to envelop the active material, the content of the binder in the slurry can be about one-half of that in the case where a general-purpose metal foil is used as a current collector, and the content can be set to, for example, about 0.5% by weight.

A metal coating having a desired thickness is formed on the surface of the resin base material subjected to the conductive treatment by using a method such as a plating method, a vapor deposition method, a sputtering method, or a thermal spraying method, thereby giving a metal-resin composite porous body.

A coating of aluminum can be formed by using a method of plating the surface of the resin base material, which has been made to be electrically conductive, in a molten salt bath containing an aluminum component, according to the method described in WO 2011/118460 A.

A coating of copper can be formed by using a method of plating the surface of the resin base material, which has been made to be electrically conductive, in an aqueous plating bath containing a copper component.

—Removal of Resin Base Material—

Next, the resin base material is removed from the metal-resin composite porous body, thereby giving a metal porous body.

When the metal coating is an aluminum coating, if the resin base material is removed by burning the metal-resin composite porous body, an oxide film is formed on the surface of the resulting aluminum porous body. Accordingly, in this case, the metal-resin composite porous body is thermally decomposed in a molten salt. The thermal decomposition in a molten salt is performed in the following manner.

The resin base material (that is, a metal-resin composite porous body) having an aluminum plating layer formed on the surface thereof is immersed in a molten salt, and the resin base material is heated while applying a negative potential to the aluminum plating layer to decompose the resin base material. When a negative potential is applied to the aluminum plating layer with the resin base material immersed in the molten salt, the resin base material can be decomposed without oxidizing aluminum. Although the heating temperature can be appropriately selected in accordance with the type of the resin base material, the treatment needs to be performed at a temperature equal to or lower than the melting point (660° C.) of aluminum in order to avoid melting of aluminum. A preferred temperature range is 500° C. or higher and 600° C. or lower. A negative potential to be applied is on the minus side of the reduction potential of aluminum and on the plus side of the reduction potential of the cation in the molten salt.

For the thermal decomposition of the resin base material, a halide salt of an alkali metal or alkaline earth metal with which the electrode potential of aluminum is lowered can be used as the molten salt. More specifically, the molten salt preferably contains one or more salts selected from the group consisting of lithium chloride (LiCl), potassium chloride (KCl), sodium chloride (NaCl) and aluminum chloride (AlCl₃). In this manner, an aluminum porous body which has interconnected pores, has a thin oxide layer on the surface thereof and has a low oxygen content can be obtained.

The copper porous body is obtained by heating a metal-resin composite porous body to remove the resin base material by burning, and heating the resulting product in a reducing atmosphere to reduce copper oxide at the surface of the product.

—Annealing Treatment—

The aluminum porous body obtained in the above-mentioned manner is subjected to a heating treatment by heating the porous body in a reducing atmosphere or an inert atmosphere at a temperature of 250 to 400° C. for 1 hour or more, and then is cooled by air cooling or cooling in a furnace. The hardness of the resulting three-dimensional network aluminum porous body is controlled so as to be 1.0 GPa or less by this annealing treatment.

On the other hand, the copper porous body is heat-treated in a reducing atmosphere or an inert atmosphere at a temperature of 400 to 650° C. for 1 hour or more, and then is cooled by air cooling or cooling in a furnace. The hardness of the resulting three-dimensional network copper porous body is controlled so as to be 2.2 GPa or less by this annealing treatment.

The hardness of the resulting three-dimensional network metal porous body can be measured by embedding the metal porous body in a resin, cutting the metal porous body, polishing the cut surface, and pressing an indenter of a nanoindenter against the cross-section of a skeleton (plating).

The nanoindenter is a measurement means used for measuring the hardness of a minute area.

(Active Material)

—Positive Electrode Active Material—

A material capable of insertion or disorption of lithium ions can be used as a positive electrode active material.

Examples of the material of the positive electrode active material include lithium cobalt oxide (LiCoO₂), lithium nickel oxide (LiNiO₂), lithium cobalt nickel oxide (LiCoₓNi₁₋ₓO₂; 0<x<1), lithium manganese oxide (LiMn₂O₄), lithium manganese oxide compounds (LiM_{y}Mn_{2-y}O₄); M=Cr, Co or Ni, 0<y<1), and lithium acid. Other examples of the material of the positive electrode active material include an olivine compound, for example, lithium transition metal oxides such as lithium iron phosphate (LiFePO₄) and LiFe_{0.5}Mn_{0.5}PO₄.

Other examples of the material of the positive electrode active material include lithium metals of which skeleton is a chalcogenide or a metal oxide (namely, coordinate compounds including a lithium atom in a crystal of a chalcogenide or a metal oxide). Examples of the chalcogenide include sulfides such as TiS₂, V₂S₃, FeS, FeS₂, and LiMS_{z} (wherein M represents a transition metal element (e.g., Mo, Ti, Cu, Ni, Fe, etc.), Sb, Sn or Pb, and “z” is a numerical number of 1.0 or more and 2.5 or less). Examples of the metal oxide include TiO₂, Cr₃O₈, V₂O₅, and MnO₂.

The positive electrode active material can be used in combination with a conduction aid and a binder. In addition, when the material of the positive electrode active material is a compound containing a transition metal atom, the transition metal atom contained in the material can be partially substituted with another transition metal atom. The positive electrode active materials can be used alone or in admixture of not less than two kinds. From the viewpoint of performing efficient insertion and disorption of lithium ions, preferred one among the positive electrode active materials is at least one selected from the group consisting of lithium cobalt oxide (LiCoO₂), lithium nickel oxide (LiNiO₂), lithium cobalt nickel oxide (LiCoₓNi₁₋ₓO₂; 0<x<1), lithium manganese oxide (LiMn₂O₄) and a lithium manganese oxide compound (LiM_{y}Mn_{2-y}O₄); M=Cr, Co or Ni, 0<y<1). In addition, lithium titanium oxide (Li₄Ti₅O₁₂) among the materials of the positive electrode active material can also be used as a negative electrode active material.

—Negative Electrode Active Material—

A material capable of insertion or disorption of lithium ions can be used as a negative electrode active material. Examples of the material of the negative electrode active material include graphite and lithium titanium oxide (Li₄Ti₅O₁₂).

Further, as other negative electrode active materials, metals such as metal lithium (Li), metal indium (In), metal aluminum (Al), metal silicon (Si), metal tin (Sn), metal magnesium (Mn), and metal calcium (Ca); and alloys formed by combining at least one of the above-mentioned metals and other elements and/or compounds (i.e., an alloy including at least one of the above-mentioned metals) can be employed.

The negative electrode active materials can be used alone or in admixture of not less than two kinds. From the viewpoint of performing efficient insertion and disorption of lithium ions and performing efficient formation of an alloy with lithium, preferred ones among the negative electrode active materials are graphite, lithium titanium oxide (Li₄Ti₅O₁₂), a metal selected from the group consisting of Li, In, Al, Si, Sn, Mg and Ca and an alloy including at least one of these metals.

(Solid Electrolyte for Filling into Three-Dimensional Network Metal Porous Body)

As the solid electrolyte for filling into pores of the three-dimensional network metal porous body, a sulfide solid electrolyte having high lithium ion conductivity is preferably used. Examples of the sulfide solid electrolyte include sulfide solid electrolytes containing lithium, phosphorus and sulfur as constituent elements. The sulfide solid electrolyte can further contain elements such as O, Al, B, Si, and Ge as the constituent elements.

Such a sulfide solid electrolyte can be obtained by a publicly known method. Examples of such a method include a method using lithium sulfide (Li₂S) and diphosphorus pentasulfide (P₂S₅) as starting materials, in which Li₂S and P₂S₅ are mixed in a molar ratio (Li₂S/P₂S₅) of 80/20 to 50/50, and the resulting mixture is melted and quenched (melting and rapid quenching method) and a method of mechanically milling the above-mentioned mixture (mechanical milling method).

The sulfide solid electrolyte obtained by the above-mentioned method is amorphous. In the present invention, for the sulfide solid electrolyte, an amorphous sulfide solid electrolyte can be used, or a crystalline sulfide solid electrolyte obtained by heating the amorphous sulfide solid electrolyte can be used. Improvement of lithium ion conductivity can be expected by crystallization.

(Conduction Aid)

In the present invention, publicly known or commercially available substances can be used as the conduction aid. The conduction aid is not particularly limited, and examples thereof include carbon black such as acetylene black and Ketjen Black; activated carbon; and graphite. When graphite is used as the conduction aid, the shape thereof can be any of a spherical form, a flake form, a filament form, and a fibrous form such as carbon nanotube (CNT).

(Slurry of Active Material and the Like)

To the active material and the solid electrolyte (also referred to as “active material and the like”), a conduction aid and a binder are added as required, and thereafter, an organic solvent, water and the like are mixed in the resulting mixture to prepare a slurry.

The binder can be one commonly used in the positive electrode for a lithium secondary battery. Examples of materials of the binder include fluorine resins such as PVDF and PTFE; polyolefin resins such as polyethylene, polypropylene, and an ethylene-propylene copolymer; and thickening agents (e.g., a water-soluble thickening agent such as carboxymethyl cellulose, xanthan gum, and pectin agarose).

The organic solvent used in preparing the slurry can be an organic solvent which does not adversely affect materials (i.e., an active material, a conduction aid, a binder, and a solid electrolyte as required) to be filled into the metal porous body, and a proper solvent can be appropriately selected from such organic solvents. Examples of the organic solvent include n-hexane, cyclohexane, heptane, toluene, xylene, trimethylbenzene, dimethyl carbonate, diethyl carbonate, ethyl methyl carbonate, propylene carbonate, ethylene carbonate, butylene carbonate, vinylene carbonate, vinyl ethylene carbonate, tetrahydrofuran, 1,4-dioxane, 1,3-dioxolan, ethylene glycol, N-methyl-2-pyrrolidone and the like. Further, when water is used for the solvent, a surfactant can be used for enhancing filling performance.

The binder can be mixed with a solvent in forming the slurry, or can be dispersed or dissolved in the solvent in advance. For example, water-based binders such as an aqueous dispersion of a fluorine resin in which the fluorine resin is dispersed in water, and an aqueous solution of carboxymethylcellulose; and an NMP solution of PVDF that is usually used in employing a metal foil as a current collector can be used. In the present invention, since the positive electrode active material comes to have a structure of being enveloped by a conductive skeleton by using a three-dimensional porous body as the current collector, a water-based solvent can be used, and the use and reuse of an expensive organic solvent and environmental consideration become unnecessary. Therefore, it is preferred to use a water-based binder containing at least one binder selected from the group consisting of a fluorine resin, a synthetic rubber and a thickening agent, and a water-based solvent.

The contents of the components in the slurry are not particularly limited, and they can be appropriately determined according to the binder and the solvent to be used.

(Filling of Active Material and the Like into Three-Dimensional Network Metal Porous Body)

Filling of the active material and the like into pores of the three-dimensional network metal porous body can be performed by introducing, for example, a slurry of the active material and the like into the voids within the three-dimensional network metal porous body with a use of a publicly known method such as a method of filling by dipping or a coating method. Examples of the coating method include a roll coating method, an applicator coating method, an electrostatic coating method, a powder coating method, a spray coating method, a spray coater coating method, a bar coater coating method, a roll coater coating method, a dip coater coating method, a doctor blade coating method, a wire bar coating method, a knife coater coating method, a blade coating method, and a screen printing method.

The amount of the active material to be filled is not particularly limited, and for example, the amount can be about 20 to 100 mg/cm², and preferably about 30 to 60 mg/cm².

It is preferred that the electrode is pressed in a state in which the slurry is filled into the current collector.

The thickness of the electrode is usually reduced to about 100 to 450 μm by this pressing. The thickness of the electrode is preferably 100 to 250 μm in the case of an electrode of a secondary battery for a high power, and preferably 250 to 450 μm in the case of an electrode of a secondary battery for a high capacity. The pressing step is preferably performed with a use of a roller pressing machine. Since the roller pressing machine is the most effective in smoothing an electrode surface, the possibility of short circuit can be reduced by pressing with the roller pressing machine.

A heating treatment can be performed after the pressing step as required in the production of an electrode. When the heating treatment is performed, the binder is melted to enable the active material to bind to the three-dimensional network metal porous body more firmly. In addition, the active material is calcined to improve the strength of the active material.

The temperature of the heating treatment is 100° C. or higher, and preferably 150° C. to 200° C.

The heating treatment can be performed under ordinary pressure or can be performed under reduced pressure. However, it is preferably performed under reduced pressure. When the heating treatment is performed under reduced pressure, the pressure is, for example, 1000 Pa or less, and preferably 1 to 500 Pa.

The heating time is appropriately determined according to the atmosphere of heating and the pressure at the time of heating. The heating time can be usually 1 to 20 hours, and preferably 5 to 15 hours.

Moreover, a drying step can be performed according to an ordinary method between the filling step and the pressing step, as required.

(Solid Electrolyte Membrane (SE Membrane))

The solid electrolyte membrane can be obtained by forming the above-mentioned solid electrolyte material in the form of membrane.

In the present invention, using a three-dimensional network metal porous body filled with the active material as a base material, a solid electrolyte membrane is obtained by forming a film of an inorganic solid electrolyte material is formed on one surface of the base material by a vapor deposition method, a sputtering method, a laser ablation method or the like.

For the formation of a solid electrolyte membrane by the vapor deposition method, for example, a method as described in Japanese Unexamined Patent Publication No. 2009-167448 (a vacuum deposition method in which a material loaded into a deposition material container is irradiated with electron beams or laser beams to generate a vapor and thereby a deposition film is deposited on a substrate), or a resistance heating vapor deposition method as described in Japanese Unexamined Patent Publication No. 2011-142034 can be employed.

The solid electrolyte membrane is formed on one surface of the current collector for a positive electrode and one surface of the current collector for a negative electrode, respectively.

The thickness of the solid electrolyte membrane is preferably set to 1 to 500 μm.

### EXAMPLES

Hereinafter, the lithium-ion secondary battery of the present invention will be described in more detail by way of examples. However, such examples are merely provided for the purpose of illustration, and the present invention is not limited to these examples. All modifications which fall within the meaning and scope of the claims and the equivalents thereof are embraced by the present invention.

Further, although a secondary battery in which a solid electrolyte is used as a nonaqueous electrolyte will be hereinafter shown as an example, it can be easily understood by those skilled in the art that a secondary battery in which a nonaqueous electrolytic solution is used as a nonaqueous electrolyte also exhibits the same effect as those of the secondary batteries in the following examples.

In the following production examples, the hardness of the three-dimensional network aluminum porous body and the three-dimensional network copper porous body was evaluated by embedding the porous body in a resin, cutting the metal porous body, polishing the cut surface, and pressing an indenter of a nanoindenter against the cross-section of a skeleton (plating).

### Production Example 1

### Production of Aluminum Porous Body 1

(Formation of Conductive Layer)

A polyurethane foam (porosity: 95%, thickness: 1 mm, number of pores per inch (pore diameter 847 μm): 30 pores) was used as a resin base material. An aluminum film was formed on the surface of the polyurethane foam by a sputtering method so as to have a weight per unit area of 10 g/m² to form a conductive layer.

(Molten Salt Plating)

The polyurethane foam having a conductive layer formed on the surface thereof was used as a workpiece. After the workpiece was loaded in a jig having an electricity supply function, the jig was placed in a glove box which was kept in an argon atmosphere and a low moisture condition (dew point: −30° C. or lower), and then immersed in a molten salt aluminum plating bath (composition: 33 mol % of 1-ethyl-3-methylimidazolium chloride (EMIC) and 67 mol % of AlCl₃) at a temperature of 40° C. The jig holding the workpiece was connected to the cathode of a rectifier. An aluminum plate (purity 99.99%) of the counter electrode was connected to the anode. Next, the workpiece was plated by passing a direct current at a current density of 3.6 A/dm² for 90 minutes between the workpiece and the counter electrode while stirring the molten salt aluminum plating bath, thereby giving an [aluminum-resin composite porous body 1” in which an aluminum plating layer (aluminum weight per unit area: 150 g/m²) was formed on the surface of the polyurethane foam. Stirring of the molten salt aluminum plating bath was performed by using a Teflon (registered trademark) rotor and a stirrer. The current density was calculated based on the apparent area of the polyurethane foam.

(Removal of Polyurethane Foam)

The “aluminum-resin composite porous body 1” was immersed in a LiCl—KCl eutectic molten salt at a temperature of 500° C. Then a negative potential of −1 V was applied to the aluminum-resin composite porous body 1 for 30 minutes. Air bubbles resulting from the decomposition reaction of the polyurethane were generated in the molten salt. Thereafter, the resulting product was cooled to room temperature in the atmosphere and then washed with water to remove the molten salt, to give a “pre-annealing aluminum porous body 1” from which the polyurethane foam had been removed.

(Annealing Treatment)

The “pre-annealing aluminum porous body 1” was subjected to a heating treatment by heating at 345° C. for 1.5 hours in a nitrogen atmosphere, and was naturally cooled (cooled in a furnace) to obtain an “aluminum porous body 1”. The hardness of the aluminum porous body 1 was measured by using a nanoindenter, and consequently the hardness was 0.85 GPa.

### Production Example 2

### Production of Aluminum Porous Body 2

An “aluminum porous body 2” was obtained by performing the same operations as in Production Example 1 except for heat-treating a pre-annealing aluminum porous body at 200° C. for 30 minutes in place of heat-treating the porous body at 345° C. for 1.5 hours. The hardness of the “aluminum porous body 2” was 1.12 GPa.

### Production Example 3

### Production of Copper Porous Body 1

(Formation of Conductive Layer)

A polyurethane foam similar to that used in Production Example 1 was used as a resin base material. A copper film was formed on the surface of the polyurethane foam by a sputtering method so as to have a weight per unit area of 10 g/m² to form a conductive layer.

(Electroplating)

Next, the polyurethane foam having the conductive layer formed thereon was immersed in a copper sulfate plating bath to perform electroplating, thereby giving a “copper-resin composite porous body 1” in which a copper plating layer (copper weight per unit area: 400 g/m²) was formed on the surface of the polyurethane foam was obtained.

(Removal of Polyurethane Foam)

The “copper-resin composite porous body 1” was heat-treated thereby burning to remove the polyurethane foam. Thereafter, the resulting product was reduced by heating in a reducing atmosphere to give a “pre-annealing copper porous body 1”. The hardness of the “pre-annealing copper porous body 1” was 3.14 GPa.

(Annealing Treatment)

The “pre-annealing copper porous body 1” was subjected to a heating treatment by heating at 300° C. for 1.5 hours in a nitrogen atmosphere, and then naturally cooled (cooled in a furnace) to obtain a “copper porous body 1”. The hardness of the “copper porous body 1” was 1.82 GPa.

### Production Example 4

### Production of Copper Porous Body 2

A “copper porous body 2” was obtained by performing the same operations as in Production Example 3 except for heat-treating a pre-annealing copper porous body at 300° C. for 30 minutes in place of heat-treating the porous body at 300° C. for 1.5 hours. The hardness of the “copper porous body 2” was 2.54 GPa.

### Production Example 5

### Production of Positive Electrode 1

A lithium cobalt oxide powder (average particle size: 5 μm) was used as a positive electrode active material. The lithium cobalt oxide powder (positive electrode active material), Li₂S—P₂S₂ (solid electrolyte), acetylene black (conduction aid), and PVDF (binder) were mixed in proportions by mass (positive electrode active material/solid electrolyte/conduction aid/binder) of 55/35/5/5. To the resulting mixture, N-methyl-2-pyrolidone (organic solvent) was added dropwise, and thereafter, the resulting mixture was mixed to prepare a paste-like positive electrode mixture slurry. The resulting positive electrode mixture slurry was supplied to the surface of the “aluminum porous body 1”, and then pressed against the “aluminum porous body 1” under the load of 5 kg/cm² by a roller to be filled into pores of the “aluminum alloy porous body 1”. Thereafter, the “aluminum porous body 1” filled with the positive electrode mixture was dried at 100° C. for 40 minutes to remove the organic solvent, thereby giving a “positive electrode 1”.

### Production Example 6

### Production of Positive Electrode 2

A “positive electrode 2” was obtained by performing the same operations as in Production Example 5 except for using the “aluminum porous body 2” in place of the “aluminum porous body 1”.

### Production Example 7

### Production of Positive Electrode 3

A “positive electrode 3” was obtained by performing the same operations as in Production Example 5 except for using the “pre-annealing aluminum porous body 1” in place of the “aluminum porous body 1”.

### Production Example 8

### Production of Negative Electrode 1

A lithium titanium oxide powder (average particle size: 2 μm) was used as a negative electrode active material. The lithium titanium oxide powder (negative electrode active material), Li₂S—P₂S₂ (solid electrolyte), acetylene black (conduction aid), and PVDF (binder) were mixed in proportions by mass (positive electrode active material/solid electrolyte/conduction aid/binder) of 50/40/5/5. To the resulting mixture, N-methyl-2-pyrolidone (organic solvent) was added dropwise, and the resulting mixture was mixed to prepare a paste-like negative electrode mixture slurry. The resulting negative electrode mixture slurry was supplied to the surface of the “copper porous body 1”, and then pressed against the “copper porous body 1” under the load of 5 kg/cm² by a roller to be filled into pores of the “copper porous body 1”. Thereafter, the “copper porous body 1” filled with the negative electrode mixture was dried at 100° C. for 40 minutes to remove the organic solvent, and thereby, a “negative electrode 1” was obtained.

### Production Example 9

### Production of Negative Electrode 2

A “negative electrode 2” was obtained by performing the same operations as in Production Example 8 except for using the “copper porous body 2” in place of the “copper porous body 1”.

### Production Example 10

### Production of Negative Electrode 2

A “negative electrode 3” was obtained by performing the same operations as in Production Example 8 except for using the “pre-annealing copper porous body 1” in place of the “copper porous body 1”.

### Production Example 11

### Production of Solid Electrolyte Membrane 1

Li₂S—P₂S₂ (solid electrolyte) which is a glass-like lithium ion conductive solid electrolyte was ground to a size of 100-mesh or less with a mortar. Then, the ground Li₂S—P₂S₂ was pressed to form into a disc shape of 10 mm in diameter and 1.0 mm in thickness to give a “solid electrolyte membrane 1”.

### Example 1

The “solid electrolyte membrane 1” was interposed between the “positive electrode 1” and the “negative electrode 1”, and thereafter, these electrodes and membrane were press-bonded to produce an “all-solid lithium secondary battery 1”.

### Example 2

An “all-solid lithium secondary battery 2” was produced by performing the same operations as in Example 1 except for using the “positive electrode 2” in place of the “positive electrode 1” and using the “negative electrode 2” in place of the “negative electrode 1”.

### Comparative Example 1

An “all-solid lithium secondary battery 3” was produced by performing the same operations as in Example 1 except for using the “positive electrode 3” in place of the “positive electrode 1” and using the “negative electrode 3” in place of the “negative electrode 1”.

### Test Example 1

Tests of charge-discharge cycle of the all-solid lithium secondary batteries 1 to 3 thus obtained were conducted at a current density of 100 μA/cm². The results are shown in Table 1.

TABLE 1

| | Current Collector | Current Collector | Discharge Capacity |
|---|---|---|---|
| | of Positive | of Negative | Maintenance Rate at |
| | Electrode | Electrode | 100th Cycle Test |
| Example 1 | Aluminum Porous | Copper Porous | 97 |
| | Body 1 | Body 1 | |
| Example 2 | Aluminum Porous | Copper Porous | 89 |
| | Body 2 | Body 2 | |
| Comparative | Aluminum Porous | Copper Porous | 85 |
| Example 1 | Body 3 | Body 3 | |

From the results shown in Table 1, it is found that the lithium secondary battery in which the current collector of the present invention is used has good cycle characteristics.

### INDUSTRIAL APPLICABILITY

The lithium secondary battery of the present invention can be suitably used as electric power supplies of portable electronic devices such as mobile telephones and smartphones, and electric vehicles and hybrid electric vehicles respectively using a motor as a power source.

### REFERENCE SIGNS LIST

1: POSITIVE ELECTRODE
2: NEGATIVE ELECTRODE
3: SOLID ELECTROLYTE LAYER (SE LAYER)
4: POSITIVE ELECTRODE LAYER (POSITIVE ELECTRODE BODY)
5: CURRENT COLLECTOR OF POSITIVE ELECTRODE
6: NEGATIVE ELECTRODE LAYER
7: CURRENT COLLECTOR OF NEGATIVE ELECTRODE
10: LITHIUM SECONDARY BATTERY

1. A lithium secondary battery comprising a positive electrode and a negative electrode each having as a current collector a three-dimensional network porous body, the positive electrode and the negative electrode being formed by filling at least an active material into pores of the three-dimensional network porous bodies, wherein
the three-dimensional network porous body for the positive electrode is a three-dimensional network aluminum porous body having a hardness of 1.2 GPa or less, and
the three-dimensional network porous body for the negative electrode is a three-dimensional network copper porous body having a hardness of 2.6 GPa or less.

2. The lithium secondary battery according to claim 1, wherein the three-dimensional network aluminum porous body is obtained by heat-treating an aluminum porous body in a reducing atmosphere or an inert atmosphere at a temperature of 250 to 400° C. for 1 hour or more, and then cooling the aluminum porous body by air cooling or cooling in a furnace.

3. The lithium secondary battery according to claim 1, wherein the three-dimensional network copper porous body is obtained by heat-treating a copper porous body in a reducing atmosphere or an inert atmosphere at a temperature of 400 to 650° C. for 1 hour or more, and then cooling the copper porous body by air cooling or cooling in a furnace.

4. The lithium secondary battery according to claim 1, wherein
the active material for the positive electrode is at least one selected from the group consisting of lithium cobalt oxide (LiCoO₂), lithium nickel oxide (LiNiO₂), lithium cobalt nickel oxide (LiCoₓNi₁₋ₓO₂; 0<x<1), lithium manganese oxide (LiMn₂O₄) and a lithium manganese oxide compound (LiM_{y}Mn_{2-y}O₄); M=Cr, Co or Ni, 0<y<1), and
the active material for the negative electrode is graphite, lithium titanium oxide (Li₄Ti₅O₁₂), a metal selected from the group consisting of Li, In, Al, Si, Sn, Mg and Ca or an alloy including at least one of these metals.

5. The lithium secondary battery according to claim 4, comprising a solid electrolyte in the pores of the three-dimensional network porous body, wherein the solid electrolyte is a sulfide solid electrolyte containing lithium, phosphorus and sulfur as constituent elements.
